(19) United States
(12) Patent Application Publication
(10) Pub. No.: US 2022/0140716 A1
(43) Pub. Date: May 5, 2022

(54) AN APPARATUS AND A METHOD FOR PRODUCTION OF ELECTRICAL ENERGY

(71) Applicant: Umberto GABRIELLI, BOLOGNA (IT)

(72) Inventor: Umberto GABRIELLI, BOLOGNA (IT)

(21) Appl. No.: 17/429,542

(22) PCT Filed: Feb. 14, 2020
(86) PCT No.: PCT/IB2020/051241

§ 371 Date: Aug. 9, 2021

(30) Foreign Application Priority Data
Feb. 18, 2019 (IT) 102019000002279

(51) Int. Cl. H02K 31/02

(52) U.S. Cl. CPC H02K 31/02

(57) ABSTRACT

A first and a second type of apparatus for production of electrical energy are described, as well as a first and second type of methods for the production of electrical energy.

### FIELD OF THE INVENTION

The present invention relates to the technical sector of apparatuses and methods for production of electrical energy, in particular apparatuses and methods based on the Faraday-Neumann-Lenz law. This law relates to electromagnetic induction and establishes that when the flow of the magnetic field through the surface delimited by an electric circuit is variable over time, an induced electromotive force is generated that is equal to the opposite of the flow time variation.

### DESCRIPTION OF THE PRIOR ART

Apparatus for production of electrical energy are known, which actuate relative methods for the production of electrical energy, in which a magnet of a system of magnets is placed in relative motion with respect to one or more coils, externally of the coils, generating an induced electromotive force, but these devices do not have a high performance in terms of electrical energy produced with respect to the electrical energy spent in moving the magnet or the system of magnets for the production of electrical energy. The dynamo illustrates an example of these apparatuses for production of electrical energy.

So there remains the need to increase the performance of the present apparatus for production of electrical energy, in particular for enabling fruitful domestic use. Thus there emerges a need to produce electrical energy, in particular as an alternative to electric turbines, also at the domestic level.

### SUMMARY OF THE INVENTION

The main aim of the present invention consists in reducing and/or obviating the above-cited disadvantages with respect to the apparatuses and methods for electrical energy production of known type.

In particular, the main objective of the present invention is to obtain high energy performance.

A further objective of the present invention consists in providing an apparatus for production of electrical energy which gives high performance and needs low input energy.

A further aim of the present invention is to provide apparatuses and methods for production of electrical energy which are of small dimensions, simple and reliable and which have relatively modest costs with respect to the objectives that are to be attained, enabling virtually all potential customers to produce electrical energy.

These aims and objectives are attained with the apparatuses and methods according to the independent claims, in particular with a first type of embodiment of the apparatus for energy production according to claim 1, with a first type of embodiment of the method for energy production according to claims 8, with a second type of embodiment of the apparatus for energy production according to claim 3, and with a second type of embodiment of the method for energy production according to claim 10.

In accordance with the first embodiments and actuation, by activating the rotation shaft in a first direction and with a relative rotation velocity, a rotation is caused, at least partial of the secondary magnet, the poles of which are appropriately arranged with respect to the longitudinal rotation axis. This rotation contemporaneously generates a magnetic repulsion force between the secondary magnet in rotation and a first primary magnet an attraction force between the secondary magnet in rotation and a second primary magnet, following the first primary magnet. The forces generated cause a movement of the support element with respect to the support structure in a second direction, opposite the first direction, causing a variation of the magnetic field generated by the plurality of primary magnets and a consequent induced electromotive force in each coil of the plurality of coils.

As the primary magnets are fixed to the support element, the first and the second primary magnet cannot move away autonomously from the secondary magnet in rotation. Therefore the repulsion force causes a movement of the support element, which is solidly constrained to the primary magnets, with respect to the support structure in a second direction, opposite the first direction of rotation of the secondary magnet. This causes a variation of the magnetic field generated by the plurality of primary magnets and a consequent induced electromotive force in each coil of the plurality of coils. For this reason, differently to the devices for the production of energy in which the primary magnets directly move, according to the first embodiment and actuation of the invention only the secondary magnet moves in rotation, which is small and light and thus less energy is required to move it, and it is the secondary magnet which causes the movement of the plurality of secondary magnets which in turn generate an induced electromotive force in the electrical coils (9). Consequently, by virtue of the low quantity of energy required for moving the secondary magnet in rotation, a better energy performance can be obtained with respect to the prior art.

Note that a technical expert in the sector reading the present patent application is perfectly able to reproduce the invention as defined in claims 1 and 8. This is because on the basis of the intensity of the magnetic field (i.e. the density of the magnetic flow) of the primary magnets, the arrangement of the primary magnets along the closed ring line, the magnetic induction of the secondary magnet, the arrangement thereof with respect to the closed ring line, and the arrangement of the relative rotation axis the expert can calculate the rotation velocity of the rotation shaft so that the support element is moved by the repulsion force generated by the rotation of the secondary magnet on at least a primary magnet. Obviously the technical expert in the sector is also able to define any missing parameter from among the following: the intensity of the magnetic field of the primary magnets, the arrangement of the primary magnets along the closed ring line, the magnetic induction of the secondary magnet, the arrangement thereof with respect to the closed ring line, the arrangement of the relative rotation axis and the rotation velocity of the rotation shaft, in order to design and realise a production apparatus of the first type of embodiment starting from the remaining available parameters.

In relation to the second embodiment and actuation of the invention, note that the plurality of the primary magnets longitudinally crosses each coil included and generates, in each coil, an induced electromotive force that is greater than the one that can be generated in the same conditions in the event that the magnets were moved from outside the coils without crossing them longitudinally. Therefore, in this case, the apparatus and the method of the invention has a better performance than what is obtainable with the methods and apparatuses for electrical energy production of known type.

It will be sufficient to carry out a periodic maintenance to prevent excessive wear on the moving parts to prevent a deterioration in the performance of apparatus according to the invention.

### BRIEF DESCRIPTION OF THE DRAWINGS

The characteristics of the invention will be described in the following in which some preferred but not exclusive embodiments will be described with reference to the actuation of the method for the production of electrical energy and embodiments and apparatus for the production of electrical energy according to the invention with reference to the appended tables of drawings, in which:

FIGS. 1A, 1B and 1C are schematic views of a first embodiment of the apparatus for production of electrical energy according to the invention, respectively, frontal, lateral and from above;

FIGS. 2A, 2B and 2C are schematic views of a second embodiment of the apparatus for production of electrical energy according to the invention, respectively, frontal, lateral and from above;

FIGS. 3A, 3B and 3C are schematic views of a third embodiment of the apparatus for production of electrical energy according to the invention, respectively, frontal, lateral and from above;

FIG. 4A is a schematic view from above of some components of an apparatus for production of electrical energy, according to the invention;

FIG. 4B is a schematic view from above of some components of an apparatus for production of electrical energy, according to the invention;

FIG. 4C is a schematic view from above of some components of an apparatus for production of electrical energy, according to the invention;

FIG. 5 is a perspective view of some components of an apparatus for production of electrical energy, according to the invention;

FIG. 6 is a perspective view from above of some components of an apparatus for production of electrical energy, according to the invention;

FIG. 7 is a front side view of the component of FIG. 6;

FIG. 8 is a perspective view from above of a further component of an apparatus for production of electrical energy, according to the invention;

FIG. 9 is a perspective view from above of the component of FIG. 6 to which a plurality of further components of an apparatus for production of electrical energy according to the invention are coupled;

FIG. 10 is a perspective view from above of the components of FIG. 9, coupled to the component of FIG. 8;

FIG. 11 is a view from above of some components of an apparatus for production of electrical energy, according to the invention;

FIG. 12 is a lateral view of some components of an apparatus for production of electrical energy, according to the invention; and

FIGS. 13A, 13B and 13C are schematic views, respectively frontal, lateral and from above, of a fourth embodiment of the apparatus for production of electrical energy according to the invention.

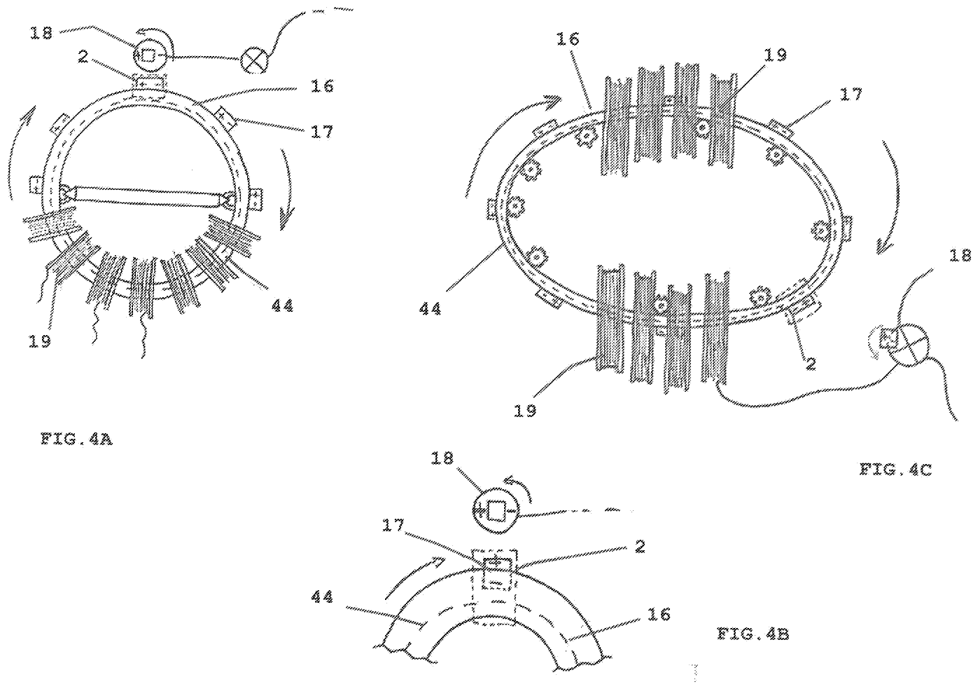

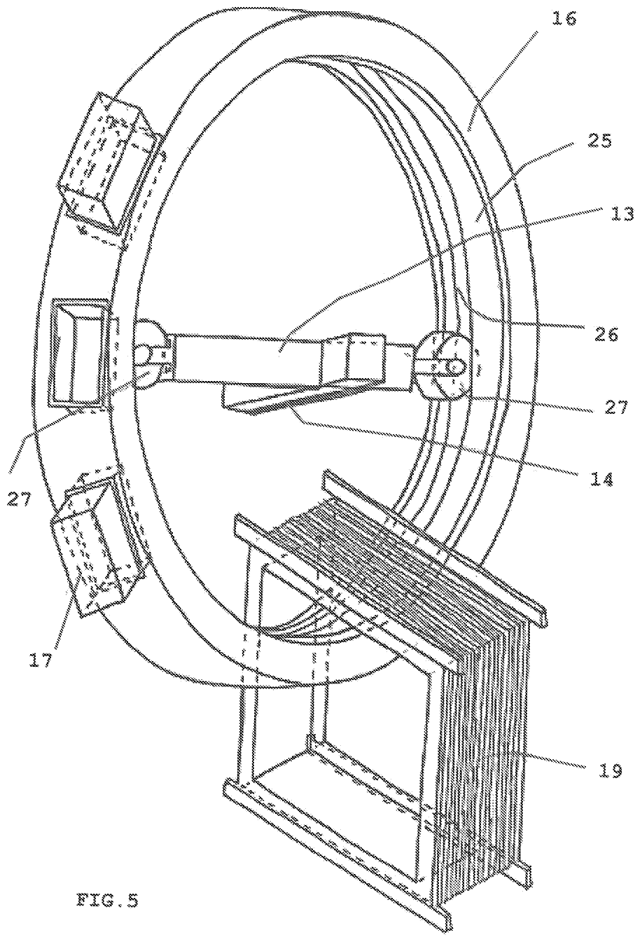

In some figures the “magnetic poles” indicated as “positive” are labelled with a “+” and magnetic poles indicated as “negative” are labelled with a “−” (see FIGS. 4A-4C).

### DESCRIPTION OF PREFERRED EMBODIMENTS

With reference to the figures, reference numeral 1 denotes an apparatus 1 for production of electrical energy according to the invention.

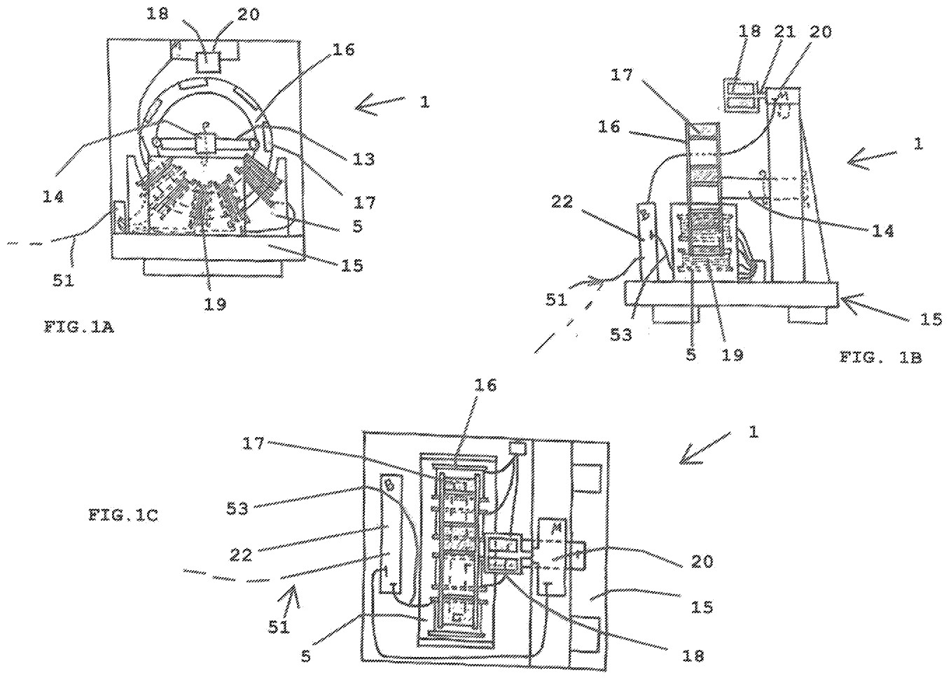

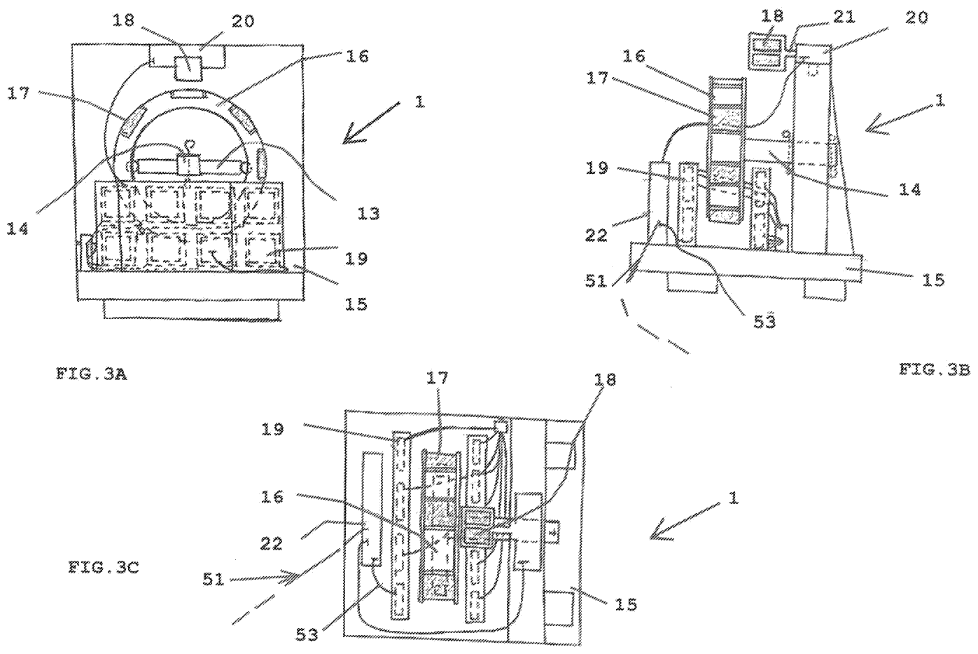

In a relative first type of embodiment (see FIGS. 1A-1C, 3A-3C, 2A-2C, 4A-4C and 5), comprises:
a support structure 15;
a plurality of primary magnets 17;
a support element 16 to which each primary magnet 17 of the plurality of primary magnets 17 is solidly fixed, arranged, one following another, along a closed ring line, preferably in sequence, wherein the support element 16 is connected to the support structure 15 with a possibility of movement, with respect to the support structure 15, so that when the support element 16 is moved, each primary magnet 17 of the plurality of primary magnets 17 follows a relative trajectory coinciding with said closed ring line;
a plurality of electrical coils 19 fixed to said support structure 15 and arranged internally of a magnetic field generated by said plurality of primary magnets 17;
rotation means 20 fixed to the support structure 15, comprising a rotation shaft 21, wherein the rotation means 20 are activatable to rotate the rotation shaft 21 at least partially about the relative longitudinal rotation axis with a relative rotation velocity in a relative first direction;
a secondary magnet 18 solidly constrained to said rotation shaft 21;

wherein the primary magnets 17, the secondary magnet 18, the arrangement of the primary magnets 17 and the secondary magnet 18, the arrangement of the relative magnetic poles, and the rotation velocity of the rotation shaft 21 are predisposed so that, by activating the rotation shaft 21 with the rotation velocity and in a relative first direction to at least partially rotate the secondary magnet 18, a magnetic repulsion force is generated between the secondary magnet 18 in rotation and a first primary magnet 17 and so as to generate a contemporary attraction force between the secondary magnet 18 in rotation and a second primary magnet 17 following the first primary magnet 17 such as to cause a movement of the support element 16 with respect to the support structure 15 in a second direction, opposite the first direction, causing a variation of the magnetic field generated by the plurality of primary magnets 17 and a consequent electromotive force induced in each coil of the plurality of coils.

In a preferred embodiment, the rotation means 20 are configured to totally rotate the rotation shaft 21 about the relative longitudinal axis, advantageously several times consecutively.

The apparatus 1 actuates a first type of embodiment of actuation of the method for the production of electrical energy of the invention which comprises following steps:
predisposing a secondary magnet 18 having a relative rotation axis;
predisposing a support element 16 to which a plurality of primary magnets 17 is fixed, placed, one following another, preferably in sequence, along a closed ring line 44, at least one of the primary magnets 17 of the plurality of primary magnets 17 being arranged in the magnetic field of the secondary magnet 18;
arranging a plurality of electrical coils 19 internally of the electrical field generated by the plurality of primary magnets 17;
at least partially setting in rotation the secondary magnet 18 with respect to the relative rotation axis in a first direction in order to generate a magnetic repulsion force between the secondary magnet 18 in rotation and at least one of the primary magnets 17 such as to cause a relative movement of the support element 16 with respect to the plurality of coils in a second direction, opposite the first direction, causing a variation of the magnetic field generated by the plurality of primary magnets 17 and a consequent electromotive force induced in each coil of the plurality of coils.

In the apparatus for production of electrical energy according to the invention, the secondary magnet 18 is preferably solidly constrained to the rotation shaft 21 with the relative south pole arranged, with respect to the rotation axis, on an opposite side to the relative north pole. This is because, in this way, a better performance can be obtained.

Likewise, it is preferable in the first type of realisation of the method for it to include the secondary magnet 18 with the relative rotation axis interposed between the relative south pole and the relative north pole.

According to a preferred embodiment, the secondary magnet 18 is set in total rotation, advantageously many times consecutively.

For constructional reasons, the closed ring line 44 is advantageously circular or oval, preferably circular.

Alternatively the rotation means 20 can comprise a relative electric motor 20, preferably fueled by a battery 22. The battery 22 is preferably rechargeable and also connectable to a source of energy (not illustrated) by means of a relative electrical wire 51. According to preferred embodiments, the battery 22 can be recharged at least partially by at least one of the electrical coils included in the apparatus 1 by means of a further electrical wire 53. Alternatively the rotation means 20 can comprise an internal combustion engine, an external combustion engine, a fuel cell, an externally-geared hydraulic motor or a molecular motor.

In the first type of embodiment, the longitudinal rotation axis is preferably arranged perpendicularly to a plane passing through the closed ring line.

The closed ring line 44 is advantageously circular or oval, preferably circular.

Preferably the apparatus 1 for production of electrical energy preferably has a relative initial configuration wherein the shaft is not activated and wherein the closed ring line 44 has the relative maximum interaction portion 2 (see FIGS. 4A-4B) which is at a minimum distance from the secondary magnet 18 with respect to the relative remaining portions. In this case, the apparatus 1 preferably has a relative initial configuration wherein a primary magnet 17 is arranged in the maximum interaction portion 2; preferably with a relative polarity opposite that of the secondary magnet 18 (see FIGS. 4A-4C). In a preferred embodiment, a relative initial configuration of the apparatus 1 for production of energy, in the maximum interaction portion 2 a primary magnet 17 is arranged with both relative polarities opposite the polarities of the secondary magnet 18 (see FIG. 4A). Obviously the remaining primary magnets 17 will have the same polarity, when arranged in the maximum interaction portion of the closed ring line.

With reference to the figures see FIGS. 4A-4C, the primary magnets 17 can be arranged in such a way that a line joining the relative polarities is tangential to the closed ring line 44 (see FIGS. 4A and 4C) or perpendicularly to the closed ring line 44 (see FIG. 4B). All the primary magnets 17 are preferably identical and have the same intensity of magnetic field.

The intensity of magnetic field of the secondary magnet 18 is advantageously about the same as that of the secondary magnets. In preferred embodiments of the invention this intensity of magnetic field is about 1.3-1.7 Tesla. The intensity is more preferably 1.4-1.6 Tesla.

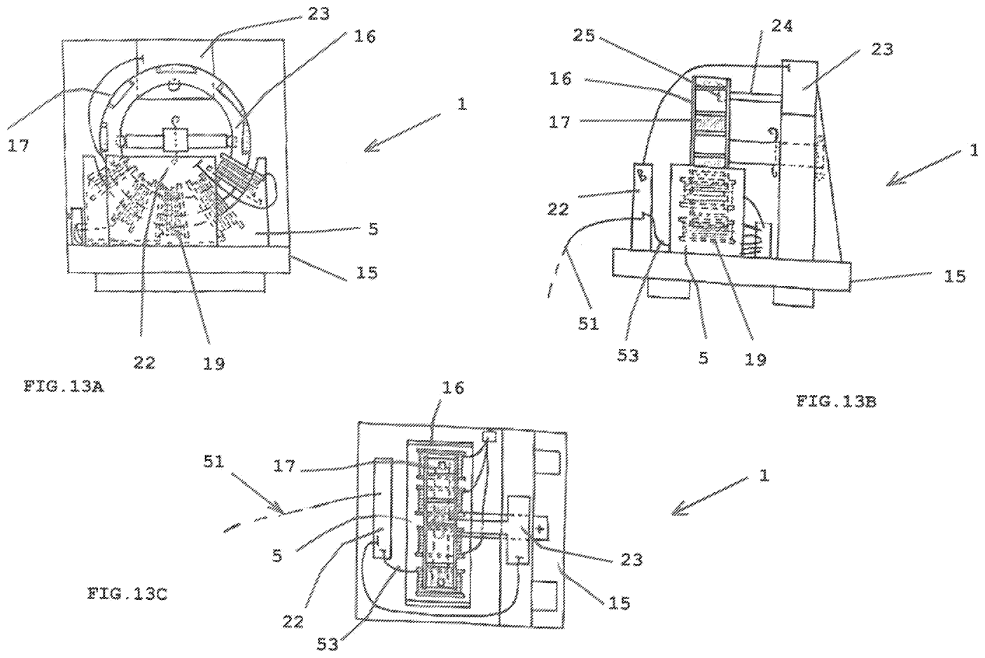

In a relative second type of embodiment (see FIGS. 13A-13C), the apparatus 1 for the production of electrical energy according to the invention comprises:
a support structure 15
a plurality of primary magnets 17;
a annular support element 16, which is closed ring-shaped to which each primary magnet 17 of the plurality of primary magnets 17 is solidly fixed, arranged, one following another, preferably in sequence, along a closed ring line 44, wherein the support element 16 has a relative central rotation axis and is connected to the support structure 15 with a possibility of relative movement, with respect to the support structure 15, in rotation about the relative rotation axis;
a plurality of electrical coils 19 fixed to said support structure 15 and arranged internally of a magnetic field generated by the plurality of primary magnets 17, wherein each electrical coil 19 of the plurality of electrical coils 19 comprises a relative plurality of relative electrical windings which surround a transversal section of the annular support element 16;
movement means 23 fixed to the support structure 15 and activatable to rotatingly move the annular support element 16 about the relative rotation axis so that each primary magnet 17 of the plurality of primary magnets 17 follows a relative trajectory coinciding with said closed ring line 44 generating a corresponding electromotive force induced in each coil of the plurality of coils.

The movement means 23 can comprise a relative motor 23, which can be electrical 23, preferably fueled by battery 22. Alternatively the rotation means 23 can comprise an internal combustion engine, an external combustion engine, a fuel cell, an externally-geared hydraulic motor or a molecular motor.

The movement means 23 preferably comprise a pin 24 activated in rotation by the motor and bearing a distal end couplable to a series of internal recesses present on the internal annular surface of the annular support 16 in closed ring in order to move the pin, by setting it in rotation about a relative central axis.

The battery 22 is preferably rechargeable and also connectable to a source of energy (not illustrated) by means of a relative electrical wire 51. According to preferred embodiments, the battery 22 can be recharged at least partially by at least one of the electrical coils included in the apparatus 1 by means of a further electrical wire 53.

The second type of embodiment of the apparatus 1 actuates a second type of embodiment of the method of the invention which comprises following steps:
predisposing a plurality of primary magnets 17 arranged, one following another, preferably in sequence, along a closed ring;
predisposing a plurality of electrical coils 19 fixed to said support structure 15 and arranged internally of a magnetic field generated by the plurality of primary magnets 17, each electrical coil 19 of the plurality of electrical coils 19 comprising a relative plurality of relative electrical windings which surround a transversal section of the closed ring;
moving the plurality of primary magnets 17 in such a way that each primary magnet 17 follows a relative trajectory coinciding with the closed ring line 44 causing a variation of the magnetic field generated by the plurality of primary magnets 17 and generating a corresponding electromotive force induced in each coil of the plurality of coils.

It is preferable that in the first type of relative embodiments of the apparatus 1 and in the first type of embodiment for actuation of the method of the invention, the support element 16 is an annular support element 16 in a closed ring shape and each electrical coil 19 of the plurality of electrical coils comprises a relative plurality of relative electrical windings which surround a transversal section of the annular support element 16. In this way, given same primary magnets 17 and the relative arrangement thereof, given same coils and the relative arrangement thereof; given same movement velocity of the secondary magnet 18, a greater induced electromotive force and therefore it is possible to obtain a greater energy performance of the apparatus 1 according to the invention (see FIGS. 1A-1C, 2A-2C, 4A-4C and 5). In this case the path of the primary magnets 17 is at least partly inside the electrical coils 19 and this enables production of a greater induced electromotive force with respect to the case in which the path of the primary magnets 17 is entirely outside the coils. Therefore the energy performance of the first embodiment of the apparatus 1 of the invention is further increased.

For constructional motives, the annular support element 16 can be formed by one or more pieces fixed to one another, for example by two half-rings.

Obviously in both the first and second types of embodiments of the apparatus 1 of the invention when the windings of the electrical coils 19 surround a transversal section of the annular support element 16, and this is stationary or in movement, there is not contact between the annular support element 16 and/or primary magnets 17 and the coils.

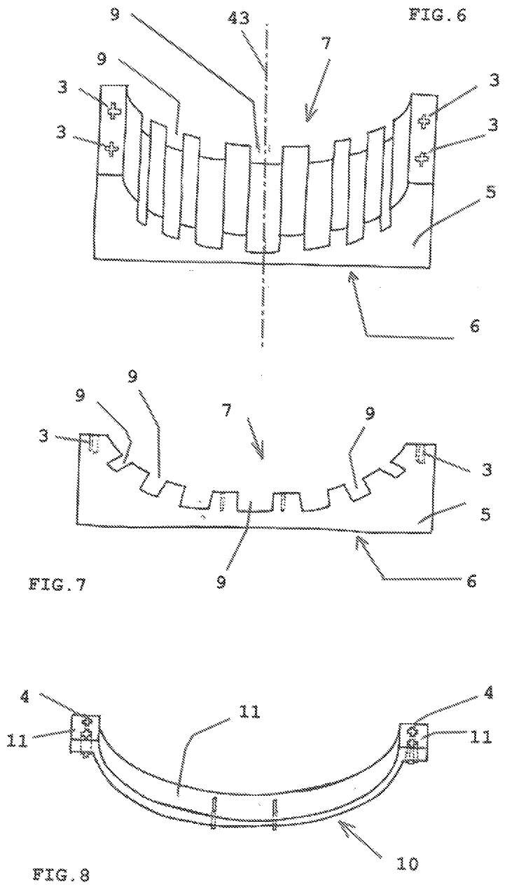

In both the first and the second type of embodiment of the apparatus 1 for production of electrical energy according to the invention, it is preferable that the support element 16 is a circular annular support element 16 which has: a relative rotation axis which is central; and a relative internal annular surface 25 defining an internal annular groove 26 (see FIG. 5), which is coaxial to the circular annular support element 16, wherein the apparatus 1 further comprises: a plurality of rolling elements 27, wherein each rolling element 27 of the plurality of rolling elements is fixed idle to the support structure 15, at a rotation axis parallel to the rotation axis of the circular annular support element 16, and is at least partially inserted in the first internal annular groove 26 in order to fix the circular annular support element 16 to the support structure 15 enabling movement thereof with respect to the support structure 15, in rotation about the relative rotation axis when the rotation shaft 21 is activated.

The circular annular support element 16 is advantageously arranged vertically with freedom to rotate with respect to a horizontal axis thereof and the rotation axis of the rolling elements 27 is horizontal.

This embodiment allows the rolling elements 27 to be wheels, rollers, spheres and bearings, preferably wheels.

Two rolling elements 27 are advantageously included, preferably two wheels, fixed diametrically to the circular annular support element 16 with the relative idle rotation axes along a horizontal plane. In this way the friction between the circular annular support element 16 and the rolling elements 27 is minimal.

In this case the support structure comprises a first fixed arm 13 arranged along a diameter, preferably horizontal, of the circular annular support element 16 having two longitudinal ends rotatably constrained to a different rolling element, and a second fixed arm 14, perpendicular to the first fixed arm 13 distally fixed to the centre of the first fixed arm 13.

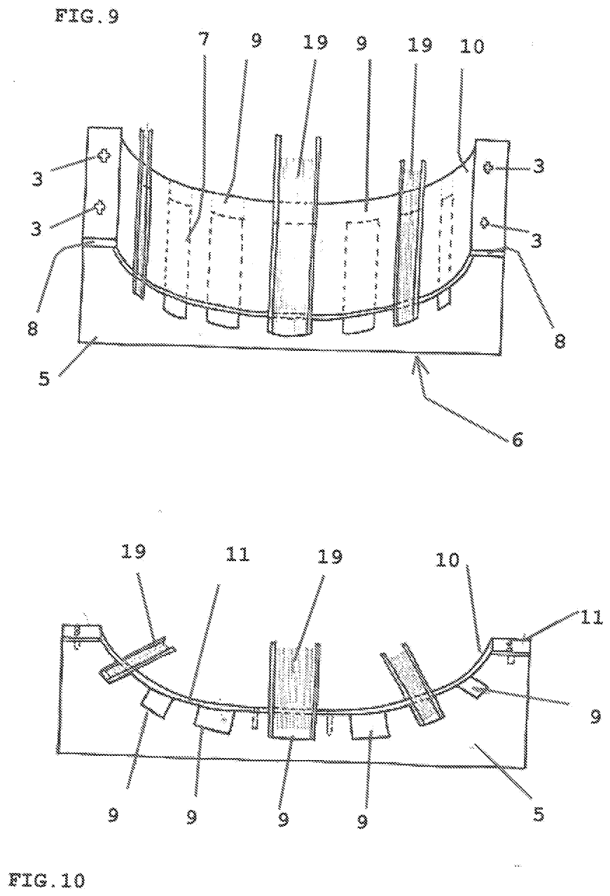

According to alternative preferred embodiments, in both the first and second type of embodiment of the apparatus 1 for the production of electrical energy according to the invention, the annular support element 16, preferably circular, is vertical and the support structure 15 comprises:
a support member 5 (see FIGS. 6, 7) having a relative lower surface 6 arranged horizontally, an upper surface, opposite the lower surface comprising: a first and a second lateral portion 8, preferably horizontal, each of which comprising relative first fixing means 3; a relative central portion 7 that is interposed between the first and the second lateral portion 8, which has a relative concavity facing upwards and which is conformed as a circular internal surface of a semi-ring having a plurality of internal longitudinal grooves 9 having a same depth, wherein each coil of the plurality of coils is inserted in a different internal longitudinal groove 9 of the plurality of internal longitudinal grooves with the relative windings substantially parallel to the axis of extension 43 (see FIG. 6) of the relative internal longitudinal groove 9 (see FIG. 9);
a blocking element 10 (see FIG. 8) comprising a first and a second relative lateral portion 11 which are facing, respectively to the first and the second lateral portion 8 of the upper surface of the support member 5, and a central portion inserted in each coil of the plurality of coils, transversally to the relative windings (see FIG. 10), and inferiorly of the annular support element 16; and
second fixing means 4 for fixing the first and the second lateral portion of the blocking element 10, respectively to the first and the second lateral portion 8 of the upper surface of the support member 5 in order to block each electrical coil 19 of the plurality of electrical coils 19 to the first support member 5, with the electrical windings surrounding a transversal section of the annular support element 16. For example the first fixing means 3 can comprise a hole 3, preferably threaded, and the second fixing means 4 can comprise a vertical through-hole (not illustrated) in every lateral portion 11 of the blocking element and two screws, bolts or plugs (not illustrated). In a preferred embodiment, illustrated in FIGS. 6-10, the second fixing means 4 can preferably be in a single body with the blocking element 10 and are arranged inferiorly in the first and the lateral portion 11 thereof and are engageable by friction coupling with the first fixing means 3 which comprise a corresponding through-hole 3.

In accordance with further relative alternative preferred embodiments, not illustrated, in both the first and second type of embodiment of the apparatus 1 for the production of electrical energy according to the invention the annular support element 16 is a circular annular support element 16 which is arranged horizontally and which has: and a relative rotation axis which is central and vertical; and a relative lower external surface defining a lower annular groove which is coaxial to the circular annular support element 16, wherein the apparatus 1 further comprises: at least three rolling elements 27, wherein each rolling element is fixed idle to the support structure 15, at a relative rotation axis that is: horizontal and arranged along a radius of the circular annular support element 16, wherein each rolling element of the plurality of rolling elements 27 is at least partially inserted in the lower annular groove in order to connect the circular annular support element 16 to the support structure 15 enabling movement thereof with respect to the support structure 15, in rotation about the relative rotation axis when the rotation shaft 21 is activated.

The rolling elements 27 are preferably three, and are arranged at a radial distance of 120° from one another, or can be four and arranged at a radial distance of 90°. These rolling elements 27 can comprise wheels, rollers, spheres and bearings, and are preferably wheels. In this embodiment too, the rotation axis of the shaft is preferably perpendicular to the circular annular support element 16.

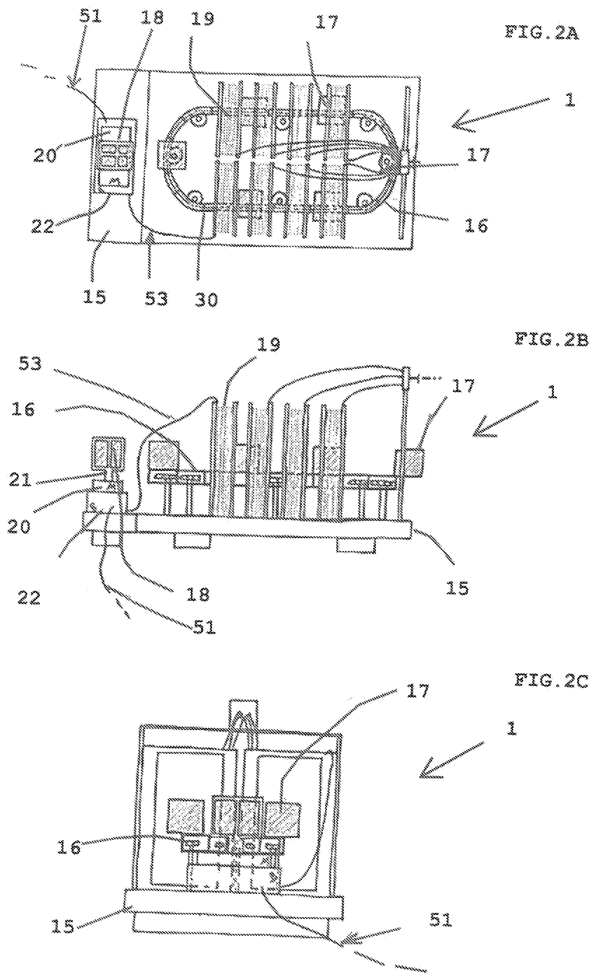

According to still further alternative preferred embodiments, in both the first and second type of embodiment of the apparatus 1 for the production of electrical energy according to the invention, the support element 16 is an annular support element 16 that is horizontally arranged and which comprises a relative internal annular surface having a plurality of recesses or through-holes arranged, preferably one following another, along a relative closed ring line, wherein the apparatus 1 further comprises a plurality of cogged wheels 30, wherein each cogged wheel 30 of the plurality of cogged wheels 30 is fixed idle to the support structure 15, at a relative vertical rotation axis, and is at least partly engaged with at least a recess 31 or through-hole 31 of the plurality of recesses or through-holes in order to fix the circular annular support element 16 to the support structure 15 enabling movement thereof with respect to the support structure 15 when the rotation shaft 21 is activated (see FIGS. 2a-2C and 11-12).

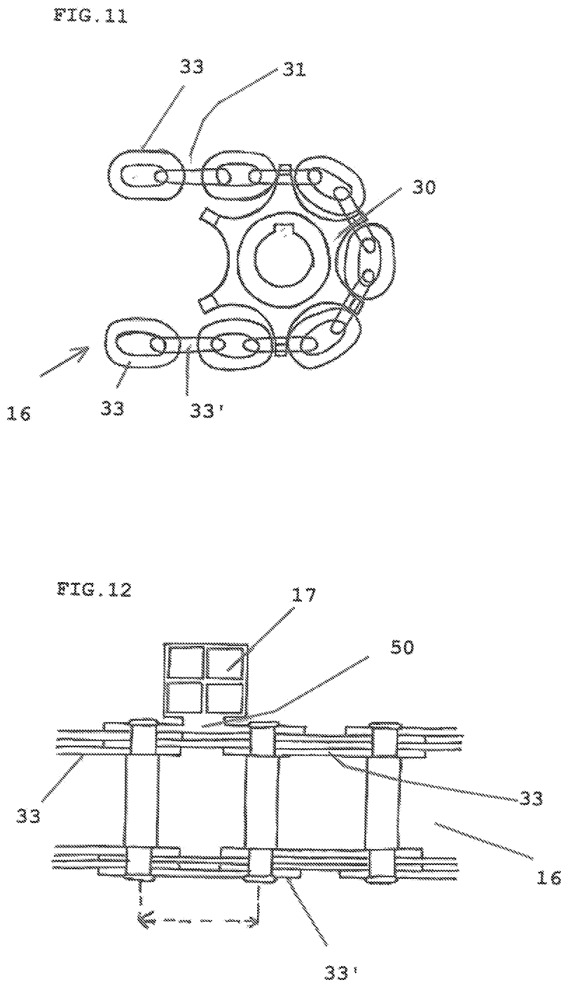

In this embodiment, the annular support element 16, which can be circular or oval, can be a conveyor belt or a conveyor chain constituted by one or more links 33, 33′ linked to one another in sequence, i.e. one link to the next (see FIG. 11), in which the primary magnets 17 are externally fixed, preferably at a recess 31 of the annular support element 16. This is because in this position the primary magnets 17 are less subject to mechanical stress during the movement of the annular support element 16. FIG. 11 illustrates a view from above of a first portion of the annular support element 16 without primary magnets 17 and at one of the cogged wheels 30.

On the other hand, FIG. 12 is a lateral view of a second portion of the annular support element 16 of FIG. 11, to which has been fixed a primary magnet 17 by means of a relative support 50.

In preferred embodiments, the annular support element 16 can be constituted by a transmission chain for vehicles.

The apparatus 1 for energy production of the invention preferably comprises a casing defining a relative external housing with, inside the housing, a pressure of lower than atmospheric pressure. In this way the friction between the support element 16 and the air is reduced and the energy performance further increased.

The apparatus 1 for energy production comprises at least 6-8 electrical coils 19, preferably made of a copper wire.

Purely by way of example, an apparatus 1 for energy production as illustrated in FIGS. 1A-1C and described in claims 1, 2 and 4 can comprise a circular annular support element 16 having a diameter of 30 cm, eight secondary magnets of 1.4-1.5 Tesla arranged one at a distance of 6.54 cm from another, a primary magnet 17 of 1.4-1.5 Tesla. In this case, the rotation shaft 21 can be activated with a rotation velocity of about 180 rpm, so that a magnetic repulsion force is generated between the secondary magnet 18 in rotation and at least one of the first primary magnets 17 so as to cause a movement of the support element 16 with respect to the support structure 15 in the second direction, causing a variation of the magnetic field generated by the plurality of primary magnets 17 and a consequent electromotive force induced in each coil of the plurality of coils.

It is understood that the above has been described by way of example and that technical-functional variants are considered to fall within the protective scope of the invention as claimed in the following.

1. An apparatus for production of electrical energy comprising:
a support structure;
a plurality of primary magnets;
a support element to which each primary magnet of the plurality of primary magnets is solidly fixed, arranged, one following another, along a closed ring line, wherein the support element is connected to the support structure with a possibility of movement, with respect to the support structure, so that when the support element is moved, each primary magnet of the plurality of primary magnets follows a relative trajectory coinciding with said closed ring line;
a plurality of electrical coils fixed to said support structure and arranged internally of a magnetic field generated by said plurality of primary magnets;
rotation means fixed to the support structure, comprising a rotation shaft, wherein the rotation means are activatable to rotate the rotation shaft at least partially about the relative longitudinal rotation axis with a relative rotation velocity in a relative first direction;
a secondary magnet solidly constrained to said rotation shaft;
wherein the primary magnets, the secondary magnet, the arrangement of the primary magnets and the secondary magnet, the arrangement of the relative magnetic poles, and the rotation velocity of the rotation shaft are predisposed so that, by activating the rotation shaft with the rotation velocity and in a relative first direction to at least partially rotate the secondary magnet, a magnetic repulsion force is generated between the secondary magnet in rotation and a first primary magnet and so as to generate a contemporary attraction force between the secondary magnet in rotation and a second primary magnet following the first primary magnet such as to cause a movement of the support element with respect to the support structure in a second direction, opposite the first direction, causing a variation of the magnetic field generated by the plurality of primary magnets and a consequent electromotive force induced in each coil of the plurality of coils.

2. The apparatus for production of electrical energy of claim 1, wherein the secondary magnet is solidly constrained to the rotation shaft with the relative south pole arranged, with respect to the rotation axis, on an opposite side to the relative north pole.

3. The apparatus for production of electrical energy of claim 1, wherein the support element is an annular support element having a closed ring shape and each electrical coil of the plurality of electrical coils comprises a relative plurality of relative electrical windings which surround a transversal section of the annular support element.

4. An apparatus for production of electrical energy comprising:
a support structure
a plurality of primary magnets;
a annular support element which is closed ring-shaped to which each primary magnet of the plurality of primary magnets is solidly fixed, arranged, one following another, along a closed ring line, wherein the support element has a relative central rotation axis and is connected to the support structure with a possibility of relative movement, with respect to the support structure, in rotation about the relative rotation axis;
a plurality of electrical coils fixed to said support structure and arranged internally of a magnetic field generated by the plurality of primary magnets, wherein each electrical coil of the plurality of electrical coils comprises a relative plurality of relative electrical windings which surround a transversal section of the annular support element;
movement means fixed to the support structure and activatable to rotatingly move the annular support element about the relative rotation axis so that each primary magnet of the plurality of primary magnets follows a relative trajectory coinciding with said closed ring line generating a corresponding electromotive force induced in each coil of the plurality of coils.

5. The apparatus for production of electrical energy of claim 4, wherein the support element is a circular annular support element which has: a relative rotation axis which is central; and a relative internal annular surface defining an internal annular groove, which is coaxial to the circular annular support element, wherein the apparatus further comprises: a plurality of rolling elements, wherein each rolling element of the plurality of rolling elements is fixed idle to the support structure, at a rotation axis parallel to the rotation axis of the circular annular support element, and is at least partially inserted in the first internal annular groove in order to fix the circular annular support element to the support structure enabling movement thereof with respect to the support structure, in rotation about the relative rotation axis when the rotation shaft is activated.

6. The apparatus for production of electrical energy of claim 4, wherein the annular support element is vertical and the support structure comprises:
a support member having a relative lower surface arranged horizontally, an upper surface, opposite the lower surface comprising: a first and a second lateral portion, each of which comprising relative first fixing means; a relative central portion that is interposed between the first and the second lateral portion, wherein the relative central portion has a relative concavity facing upwards and which is conformed as a circular internal surface of a semi-ring having a plurality of internal longitudinal grooves having a same depth, wherein each coil of the plurality of coils is inserted in a different internal longitudinal groove of the plurality of internal longitudinal grooves with the relative windings substantially parallel to the axis of extension of the relative internal longitudinal groove;
a blocking element comprising: a first and a second relative lateral portion which are facing, respectively to the first and the second lateral portion of the upper surface of the support member; and a central portion inserted in each coil of the plurality of coils, transversally to the relative windings, and inferiorly of the annular support element;
second fixing means for fixing the first and the second lateral portion of the blocking element, respectively to the first and the second lateral portion of the upper surface of the support member in order to block each electrical coil of the plurality of electrical coils to the first support member, with the electrical windings surrounding a transversal section of the annular support element.

7. The apparatus for production of electrical energy of claim 4, wherein the annular support element is a circular annular support element which is arranged horizontally and which has: and a relative rotation axis which is central and vertical; and a relative lower external surface defining a lower annular groove which is coaxial to the circular annular support element, wherein the apparatus further comprises: at least three rolling elements, wherein each rolling element is fixed idle to the support structure, at a relative rotation axis that is: horizontal and arranged along a radius of the circular annular support element, wherein each rolling element of the plurality of rolling elements is at least partially inserted in the lower annular groove in order to connect the circular annular support element to the support structure enabling movement thereof with respect to the support structure, in rotation about the relative rotation axis when the rotation shaft is activated.

8. The apparatus for production of electrical energy of claim 4, wherein the support element is an annular support element that is horizontally arranged and which comprises a relative internal annular surface having a plurality of recesses or through-holes arranged, one following another, along a relative closed ring line, wherein the apparatus further comprises a plurality of cogged wheels, wherein each cogged wheel of the plurality of cogged wheels is fixed idle to the support structure, at a relative vertical rotation axis, and is at least partly engaged with at least a recess or through-hole of the plurality of recesses or through-holes in order to fix the circular annular support element to the support structure enabling movement thereof with respect to the support structure when the rotation shaft is activated.

9. A method for production of electrical energy, comprising following steps:
predisposing a secondary magnet having a relative rotation axis;
predisposing a support element to which a plurality of primary magnets placed, one following another, along a closed ring line, at least one of the primary magnets of the plurality of primary magnets being arranged in the magnetic field of the secondary magnet;
arranging a plurality of electrical coils internally of the electrical field generated by the plurality of primary magnets;
at least partially setting in rotation the secondary magnet with respect to the relative rotation axis in a first direction in order to generate a magnetic repulsion force between the secondary magnet in rotation and at least one of the primary magnets such as to cause a relative movement of the support element with respect to the plurality of coils in a second direction, opposite the first direction, causing a variation of the magnetic field generated by the plurality of primary magnets and a consequent electromotive force induced in each coil of the plurality of coils.

10. The method for electrical energy production of claim 9, wherein the support element is an annular support element which is closed ring-shaped and each electrical coil of the plurality of electrical coils comprises a relative plurality of relative electrical windings which surround a transversal section of the annular support element.

11. A method for production of electrical energy, comprising following steps:
predisposing a plurality of primary magnets arranged, one following another, along a closed ring;
predisposing a plurality of electrical coils fixed to said support structure and arranged internally of a magnetic field generated by the plurality of primary magnets, each electrical coil of the plurality of electrical coils comprising a relative plurality of relative electrical windings which surround a transversal section of the closed ring;
moving the plurality of primary magnets in such a way that each primary magnet follows a relative trajectory coinciding with the closed ring line causing a variation of the magnetic field generated by the plurality of primary magnets and generating a corresponding electromotive force induced in each coil of the plurality of coils.

12. The apparatus for production of electrical energy of claim 3, wherein the support element is a circular annular support element which has: a relative rotation axis which is central; and a relative internal annular surface defining an internal annular groove, which is coaxial to the circular annular support element, wherein the apparatus further comprises: a plurality of rolling elements, wherein each rolling element of the plurality of rolling elements is fixed idle to the support structure, at a rotation axis parallel to the rotation axis of the circular annular support element, and is at least partially inserted in the first internal annular groove in order to fix the circular annular support element to the support structure enabling movement thereof with respect to the support structure, in rotation about the relative rotation axis when the rotation shaft is activated.

13. The apparatus for production of electrical energy of claim 3, wherein the annular support element is vertical and the support structure comprises:
a support member having a relative lower surface arranged horizontally, an upper surface, opposite the lower surface comprising: a first and a second lateral portion, each of which comprising relative first fixing means; a relative central portion that is interposed between the first and the second lateral portion, wherein the relative central portion has a relative concavity facing upwards and which is conformed as a circular internal surface of a semi-ring having a plurality of internal longitudinal grooves having a same depth, wherein each coil of the plurality of coils is inserted in a different internal longitudinal groove of the plurality of internal longitudinal grooves with the relative windings substantially parallel to the axis of extension of the relative internal longitudinal groove;
a blocking element comprising: a first and a second relative lateral portion which are facing, respectively to the first and the second lateral portion of the upper surface of the support member; and a central portion inserted in each coil of the plurality of coils, transversally to the relative windings, and inferiorly of the annular support element;
second fixing means for fixing the first and the second lateral portion of the blocking element, respectively to the first and the second lateral portion of the upper surface of the support member in order to block each electrical coil of the plurality of electrical coils to the first support member, with the electrical windings surrounding a transversal section of the annular support element.

14. The apparatus for production of electrical energy of claim 3, wherein the annular support element is a circular annular support element which is arranged horizontally and which has: and a relative rotation axis which is central and vertical; and a relative lower external surface defining a lower annular groove which is coaxial to the circular annular support element, wherein the apparatus further comprises: at least three rolling elements, wherein each rolling element is fixed idle to the support structure, at a relative rotation axis that is: horizontal and arranged along a radius of the circular annular support element, wherein each rolling element of the plurality of rolling elements is at least partially inserted in the lower annular groove in order to connect the circular annular support element to the support structure enabling movement thereof with respect to the support structure, in rotation about the relative rotation axis when the rotation shaft is activated.

15. The apparatus for production of electrical energy of claim 3, wherein the support element is an annular support element that is horizontally arranged and which comprises a relative internal annular surface having a plurality of recesses or through-holes arranged, one following another, along a relative closed ring line, wherein the apparatus further comprises a plurality of cogged wheels, wherein each cogged wheel of the plurality of cogged wheels is fixed idle to the support structure, at a relative vertical rotation axis, and is at least partly engaged with at least a recess or through-hole of the plurality of recesses or through-holes in order to fix the circular annular support element to the support structure enabling movement thereof with respect to the support structure when the rotation shaft is activated.
